(19) United States
(12) Patent Application Publication
(10) Pub. No.: US 2024/0070071 A1
(43) Pub. Date: Feb. 29, 2024

(54) CONTEXT INFORMATION TRANSLATION CACHE

(71) Applicant: Arm Limited, Cambridge (GB)

(72) Inventors: Andrew Brookfield Swaine, Sheffield (GB); Richard Roy Grisenthwaite, Cambridge (GB)

(73) Assignee: Arm Limited, Cambridge (GB)

(21) Appl. No.: 18/259,827

(22) PCT Filed: Nov. 25, 2021
(86) PCT No.: PCT/GB2021/053062

§ 371 Date: Jun. 29, 2023

(30) Foreign Application Priority Data
Dec. 31, 2020 (GB) 2020849.2

(51) Int. Cl. G06F 12/0811; G06F 12/0837; G06F 12/0875

(52) U.S. Cl. CPC G06F 12/0811; G06F 12/0837; G06F 12/0875

(57) ABSTRACT

A context-information-dependent instruction causes a context-information-dependent operation to be performed based on specified context information indicative of a specified execution context. A context information translation cache 10 stores context information translation entries each specifying untranslated context information and translated context information. Lookup circuitry 14 performs a lookup of the context information translation cache based on the specified context information, to identify whether the context information translation cache includes a matching context information translation entry which is valid and which specifies untranslated context information corresponding to the specified context information. When the matching context information translation entry is identified, the context-information-dependent operation is performed based on the translated context information specified by the matching context information translation entry.

The present technique relates to the field of data processing.

A data processing apparatus may execute instructions from one of a number of different execution contexts. For example, different applications, sub-portions of applications (such as tabs within a web browser for example) or threads of processing could be regarded as different execution contexts. A given execution context may be associated with context information indicative of that context (for example, a context identifier which can be used to differentiate that context from other contexts).

At least some examples provide an apparatus comprising: processing circuitry responsive to a context-information-dependent instruction to cause a context-information-dependent operation to be performed based on specified context information indicative of a specified execution context; a context information translation cache to store a plurality of context information translation entries each specifying untranslated context information and translated context information; and lookup circuitry to perform a lookup of the context information translation cache based on the specified context information specified for the context-information-dependent instruction, to identify whether the context information translation cache includes a matching context information translation entry which is valid and which specifies the untranslated context information corresponding to the specified context information, and when the context information translation cache is identified as including the matching context information translation entry, to cause the context-information-dependent operation to be performed based on the translated context information specified by the matching context information translation entry.

At least some examples provide an apparatus comprising: means for processing, responsive to a context-information-dependent instruction to cause a context-information-dependent operation to be performed based on specified context information indicative of a specified execution context; means for caching context information translations, to store a plurality of context information translation entries each specifying untranslated context information and translated context information; and means for performing a lookup of the means for caching based on the specified context information specified for the context-information-dependent instruction, to identify whether the means for caching includes a matching context information translation entry which is valid and which specifies the untranslated context information corresponding to the specified context information, and when the means for caching is identified as including the matching context information translation entry, to cause the context-information-dependent operation to be performed based on the translated context information specified by the matching context information translation entry.

At least some examples provide a method comprising: in response to a context-information-dependent instruction processed by processing circuitry: performing a lookup of a context information translation cache based on specified context information specified for the context-information-dependent instruction, the specified context information indicative of a specified execution context, where the context information translation cache is configured to store a plurality of context information translation entries each specifying untranslated context information and translated context information; based on the lookup, identifying whether the context information translation cache includes a matching context information translation entry which is valid and which specifies the untranslated context information corresponding to the specified context information; and when the context information translation cache is identified as including the matching context information translation entry, causing a context-information-dependent operation to be performed based on the translated context information specified by the matching context information translation entry.

Further aspects, features and advantages of the present technique will be apparent from the following description of examples, which is to be read in conjunction with the accompanying drawings, in which:

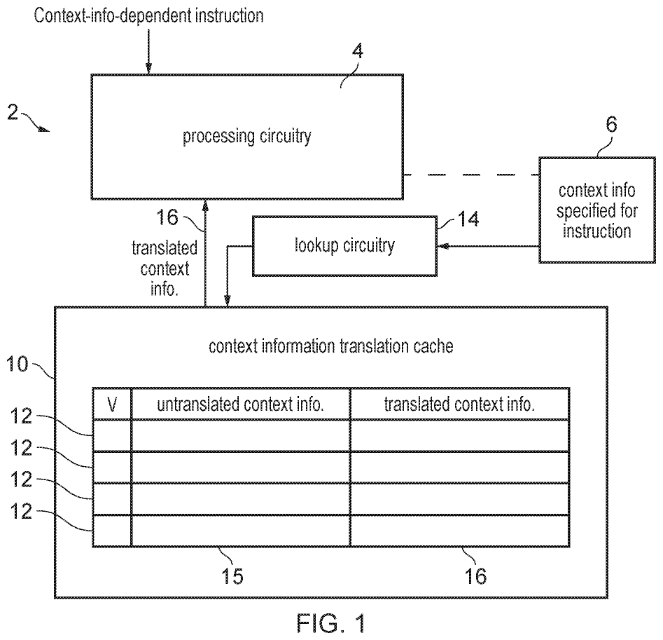

FIG. 1 schematically illustrates an example of an apparatus having a context information translation cache;

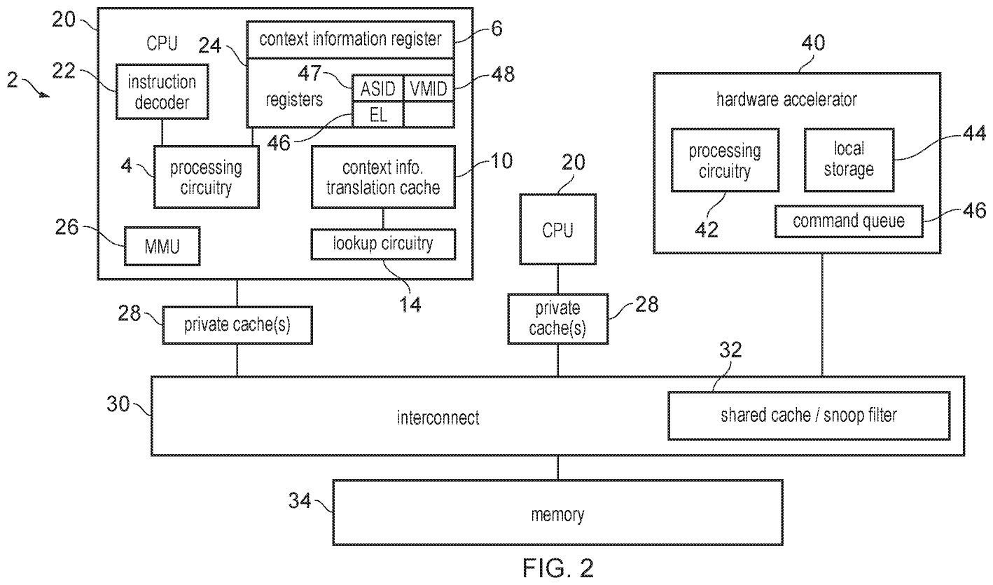

FIG. 2 shows a first example of a data processing system having a context information translation cache;

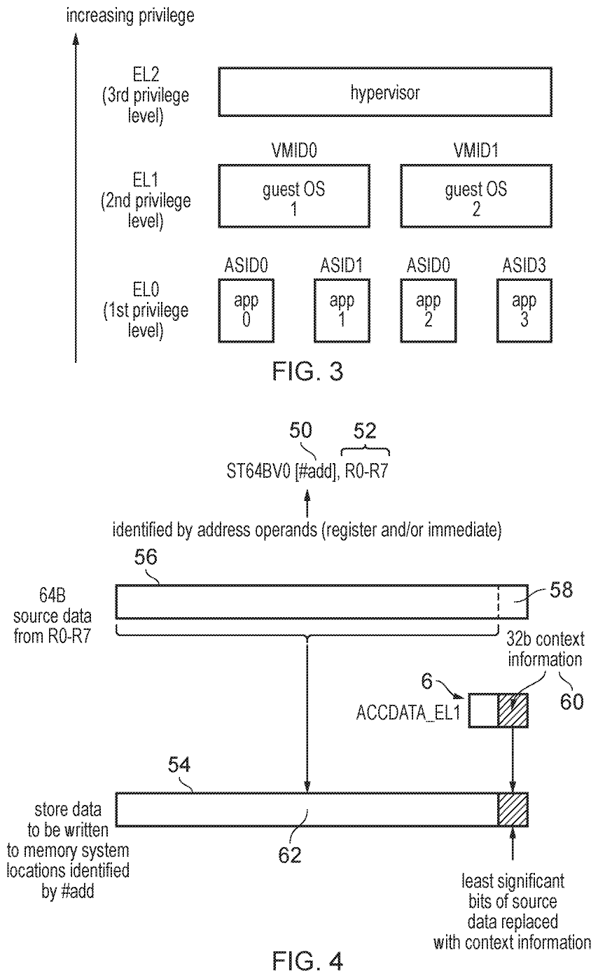

FIG. 3 illustrates a number of different privilege levels at which processing circuitry can execute program instructions;

FIG. 4 illustrates an example of a context-information-dependent type of store instruction for causing store data to be written a memory system, where a portion of the store data comprises context information;

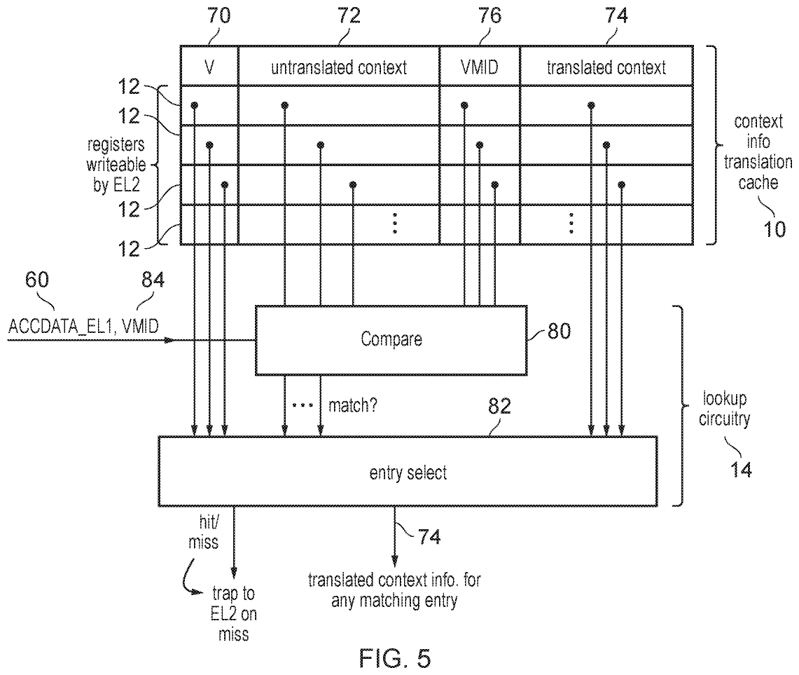

FIG. 5 shows in more detail an implementation of the context information translation cache and lookup circuitry for looking up the context information translation cache;

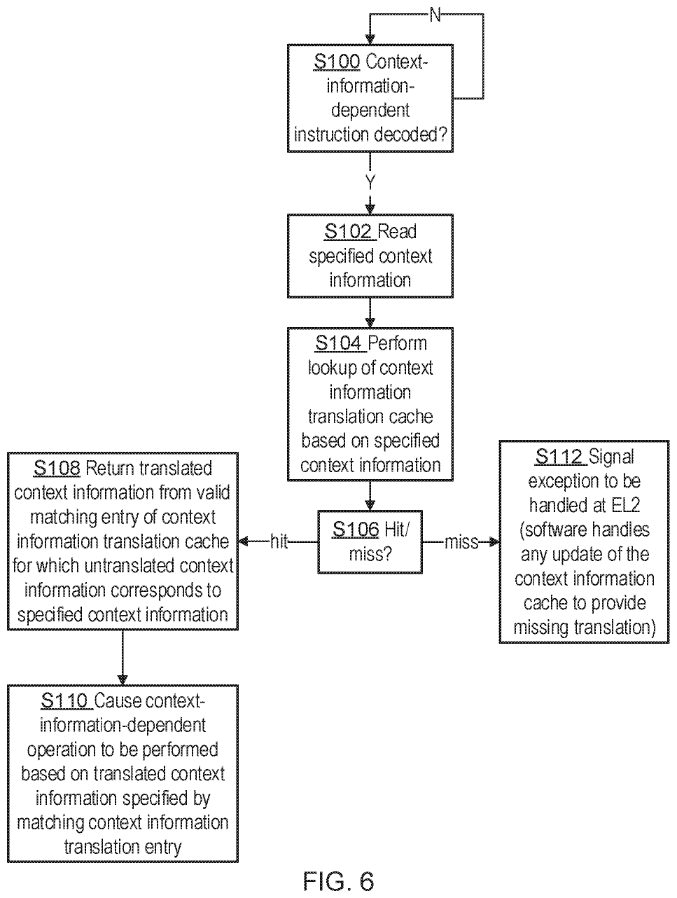

FIG. 6 is a flow diagram illustrating processing of the context-information-dependent instruction;

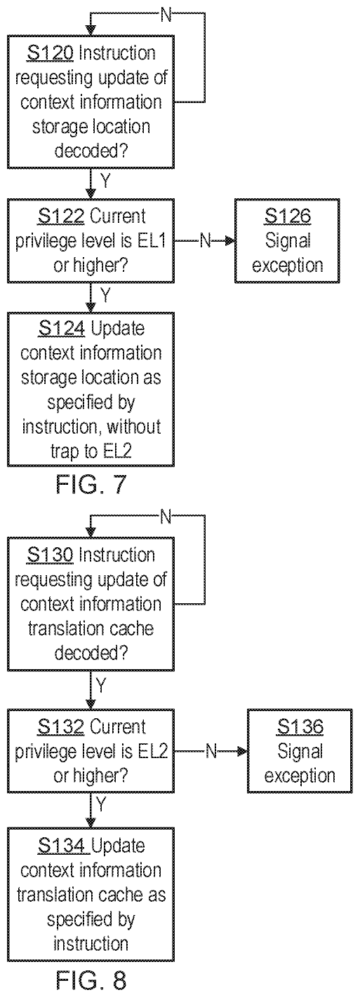

FIG. 7 is a flow diagram illustrating a method of processing an instruction which requests an update of context information;

FIG. 8 is a flow diagram showing a method of processing an instruction which requests an update of information stored in the context information translation cache;

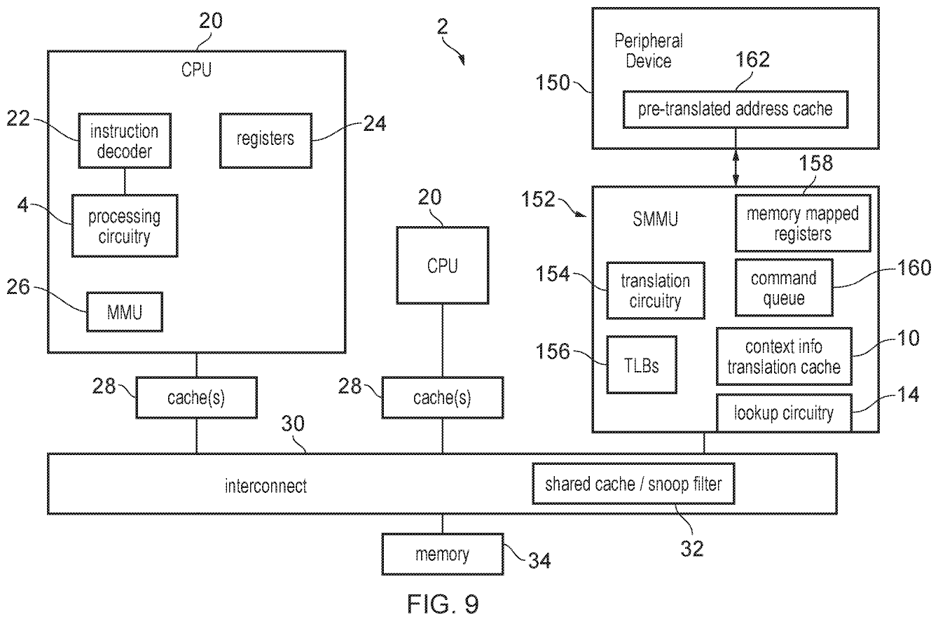

FIG. 9 shows a second example of a data processing system including a context information translation cache; and

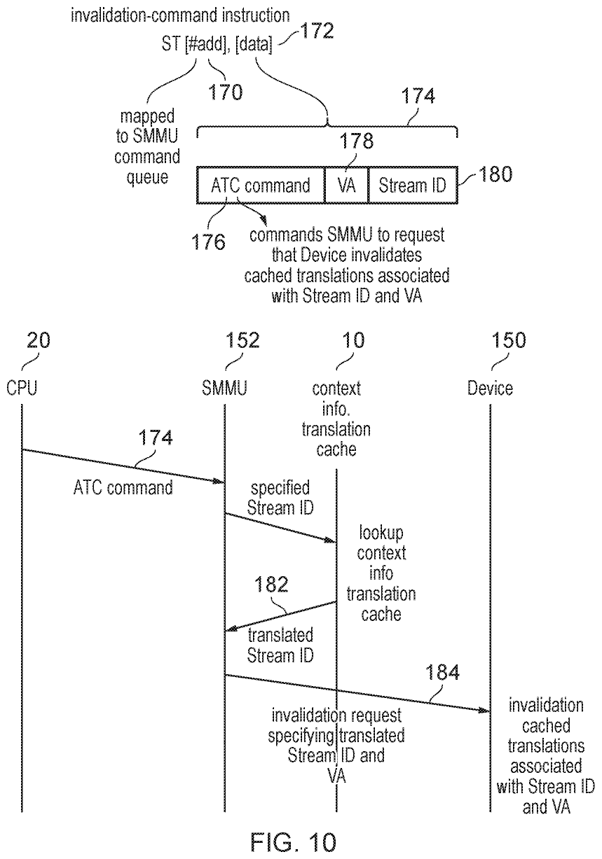

FIG. 10 illustrates use of the context information translation cache for translating context information used to control invalidation of cached translations held by a device.

In various scenarios, it can be useful to perform a context-information-dependent operation based on specified context information indicative of a specified execution context. For example, this can be useful to support virtualisation of hardware devices so that different execution contexts may share the same physical hardware device but interact with that device as if they had their own dedicated devices, with the virtualised hardware device using the context information to differentiate requests it receives from different execution contexts.

A certain software process (e.g. an operating system) may be responsible for allocating the context information associated with a particular execution context (e.g. an application running under the operating system), but in a system supporting virtualisation the process setting the context information may itself be managed by a hypervisor or other supervisor process and there may be multiple different processes which can each set their own values of context information for execution contexts. The supervisor process may remap context information to avoid conflicts between context information set by different processes operating under the supervisor process. One approach for handling that remapping is that each time an update of context information is requested by a less privileged process managed by the supervisor process, an exception may be signalled and processing may trap to the supervisor process which can then remap the updated value chosen by the less privileged process to a different value chosen by the supervisor process. However, such exceptions reduce performance.

In the techniques discussed below, a context information translation cache is provided to store a number of context information translation entries which each specify untranslated context information and translated context information. When processing circuitry processes a context-information-dependent instruction which specifies specified context information indicative of a specified execution context, lookup circuitry may perform a lookup of the context information translation cache based on the specified context information specified for the context-information-dependent instruction. The lookup identifies whether the context information translation cache includes a matching context information translation entry which is valid and which specifies the untranslated context information corresponding to the specified context information. When the context information translation cache is identified as including the matching context information translation entry, the context-information-dependent operation is caused to be performed based on the translated context information specified by the matching context information translation entry. Hence, as the context information translation cache can cache multiple mappings between untranslated context information and translated context information, this can help to reduce the number of traps to a supervisor process required for implementing the virtualisation. This can help to improve performance.

The context information translation cache functions as a cache, so that while there may be a certain maximum number N of different values of the untranslated context information which could be allocated to context information translation entries in the cache, the total number of context information translation entries provided in hardware is less than N. Hence, it is not certain that, when the lookup circuitry performs a lookup of the context information translation cache for a particular value of the specified context information, there will be a corresponding entry in the context information translation cache for which the untranslated context information corresponds to the specified context information. Sometimes the lookup may identify a cache miss.

In other words, for a given context information translation entry, the untranslated context information represented by that entry is variable (in contrast to a data structure which uses a fixed mapping to determine which particular entry identifies the translation for a given value of the specified context information, so that a given entry provided in hardware would always correspond to the same value of the untranslated context information). For the context information translation cache, the lookup performed by the lookup circuitry may be based on a content addressable memory (CAM) lookup, where the specified context information is compared with the untranslated context information in each entry in at least a subset of the context information translation cache, to determine which entry is the matching context information entry. In some implementations the looked up subset of the cache could be the entire cache, so that all of the context information translation entries would have their untranslated context information compared with the specified context information when performing the lookup. Other implementations may use a set-associative scheme for the context information translation cache so that, depending on the specified context information, a certain subset of the entries of the cache may be selected for comparison in the lookup, to reduce the number of comparisons required.

The context information translation cache could be implemented as a hardware-managed cache or as a software-managed cache.

With a hardware-managed cache, control circuitry provided as hardware circuit logic may be responsible for controlling which particular values of untranslated context information are allocated to the context information translation entries of the context information translation cache, without requiring explicit software instructions to be executed specifying the particular values of the untranslated context information to be allocated into the cache. For example, when the lookup of the context information translation cache misses, the control circuitry could perform a further lookup of a context information translation data structure stored in a memory system to identify the mapping for the specified context information which missed in the context information translation cache (similar to a page table walk performed for address translations by a memory management unit when there is a miss in a translation lookaside buffer). If a hardware-managed cache is used, software may be responsible for maintaining the underlying context information translation data structure in memory, but is not required to execute instructions to specify specific information to be allocated into entries of the context information translation cache.

However, whilst such a hardware-managed cache is possible, it may incur a greater overhead, both in terms of the circuit area and power cost of implementing the control circuitry for managing occupancy of the context information translation cache, but also in the memory footprint occupied by the underlying context information translation data structure stored in memory. In practice, the number of simultaneous mappings between untranslated context information and translated context information may be relatively small (in comparison with the number of address translation mappings used by a typical page table for controlling address translation by a memory management unit). Also, unlike address translations, which will generally be required for every memory access instruction, there may be a relatively limited number of instructions which require translation of the context information, and so the full circuit area, power and memory footprint cost of implementing a hardware-managed cache may not be justified.

Therefore, in other examples, the context information translation cache may be a software-managed cache. The software-managed cache may comprise, in hardware, storage circuitry for storing the context information translation entries and the lookup circuitry for performing the lookup of the context information translation cache, but need not have allocation control circuitry implemented in hardware for managing which particular untranslated context information values are allocated to entries of the context information translation cache. Instead, software may request updates to the context information translation cache by writing the information for a new entry of the context information translation cache to a particular storage location used to provide the corresponding context information translation entry. For example, each context information translation entry may be implemented using fields in one or more registers, with a number of sets of the one or more registers providing corresponding to the number of context information translation entries. Hence, software may request update to a certain register in order to update the information in a particular context information translation entry. The lookup circuitry may still be provided in hardware to perform a lookup of the context information translation cache based on the specified context information specified for the context-information-dependent instruction being executed, and if there is a hit in the context information translation cache then there is no need for software to step in and change any context of the context information translation cache. A software managed cache may provide a better balance between performance and hardware memory costs compared to either the previously described approach of signalling exceptions on each update to context information (which may be frequent as it may occur on every context switch, and so poor for performance) or use of a hardware-managed cache (which may be more costly in terms of circuit area, power and memory footprint).

For an example where the context information translation cache is implemented as a software-managed cache, when the lookup fails to identify any matching context information translation entry (that is, the lookup misses in the context information translation cache), the lookup circuitry may trigger signalling of an exception. The exception may cause software, such as a supervisor process, to step in and change the context of the context information translation cache to provide the missing mapping between the untranslated context information and the translated context information. After dealing with the exception, the supervisor process can then return to the previous processing and when the context-information-dependent instruction is later re-executed then the required mapping may now be present. Note that the particular steps taken to populate the cache with the missing mapping are a design choice for the particular software being executed, and so are not a feature of the hardware apparatus or the instruction set architecture.

The exception triggered on a miss in the context information translation cache may be associated with an exception type or syndrome information which identifies the cause of the exception as being due to a miss in the context information translation cache. Also, information about the context-information-dependent instruction which caused the exception may be made accessible to the software exception handler which is to be executed in response to the exception. For example, the address of the instruction which caused the exception and/or the specified context information for that instruction could be made accessible to the exception handler, to allow the exception handler to decide how to update the context information translation cache.

The processing circuitry may execute instructions at one of a number of privilege levels, including at least a first privilege level, a second privilege level with greater privilege than the first privilege level, and a third privilege level with greater privilege than the second privileged level. For example, the first privilege level could be intended for use by applications or user-level code, the second privilege level could be used for guest operating systems which manage those applications at the user level, and the third privileged level could be used for a hypervisor or other supervisor process which manages a number of guest operating systems running under it in a virtualised system. The context information translation cache described earlier can be useful for supporting virtualisation in such an environment.

The context-information-dependent instruction may be allowed to be executed at the first privilege level. For example, user-level code may be allowed to cause certain operations to be performed which depend on the specified context information. However, code at the first privilege level may not necessarily be allowed to read or write the context information itself, which could be set by a higher privilege process.

The specified context information may be read from a context information storage location (such as a register or a memory location) which is updatable in response to an instruction executed at the second privilege level. In some examples, this context information storage location may not be allowed to be updated in response to an instruction executed at the first privilege level.

The processing circuitry may allow the context information storage location to be updated in response to an instruction executed at the second privilege level without requiring a trap to the third privilege level. Since the context information translation cache can manage translating the context information specified in the context information storage location into translated context information, and there is space in the cache to simultaneously store multiple mappings between untranslated context information and translated context information, then there is no need to trap to the third privilege level each time the context information storage location is updated (e.g. on a context switch) as would be the case for the alternative technique discussed earlier. This helps to improve performance.

Where code at the second privilege level is responsible for setting of the specified context information in the context information storage location, it can be useful for each context information translation entry to also specify a second-privilege level context identifier indicative of a second-privilege level execution context which is associated with the mapping between the untranslated and translated context information specified by that context information translation entry. In this case, in the lookup of the context information translation cache, the lookup circuitry can identify, as the matching context information translation entry, a context information translation entry which is valid, specifies untranslated context information corresponding to the specified context information, and specifies the second privilege level context identifier corresponding to a current second-privilege-level context associated with the context-information-dependent instruction. For example the associated second-privilege-level context could be a guest operating system which manages the execution context in which the context-information-dependent instruction was executed at the first privilege level. Including the second-privilege-level context identifier in each context information translation entry can help to improve performance because it means that when a process at the third privilege level switches processing between different processes operating at the second privilege level, it is not necessary to invalidate all of the context information mappings defined by the outgoing process at the second privilege level, as the context information translation cache can cache mappings for two or more different second-privilege-level processes (even if they have defined aliasing values of the untranslated context information), with the second-privilege level execution context identifier distinguishing which mapping applies when a context-information-dependent instruction is executed in an execution context associated with a particular second-privilege-level context. This helps to reduce the overhead for the hypervisor or other supervisor process executing at the third privilege level when switching between processes at the second privilege level such as guest operating systems, which can help to improve performance.

Nevertheless, including the second-privileged-level context identifier (e.g. a virtual machine identifier or guest operating system identifier) in each context information translation entry is not essential. Other implementations may chose to omit this identifier, and in this case when switching between different operating systems or other processes at the second privilege level, the hypervisor or other process operating at the third privilege level may need to invalidate any entries associated with the outgoing process at the second privilege level to ensure that the incoming process at the second privilege level will not inadvertently access any of the old mappings associated with the outgoing process.

The setting of information in the context information translation cache may be the responsibility of a process operating at the third privilege level, such as a hypervisor. Hence, when the lookup of the context information translation cache fails to identify any matching context information translation entry, the lookup circuitry may trigger signalling of an exception to be handled at the third privilege level.

The context information translation entries of the context information translation cache may be allowed to be updated in response to an instruction executed at the third privilege level, but may be prohibited from being updated in response to an instruction executed at the first privilege level or the second privilege level. For example the entries of the context information translation cache may be represented by system registers which are restricted to being updated only by instructions operating at the third privilege level or higher privileges.

The context information translation cache can be useful for improving performance associated with any context-information-dependent instruction which, when executed, causes the processing circuitry to cause a context-information-dependent operation to be performed. In some cases the context-information-dependent operation could be performed by the processing circuitry itself. For other types of context-information-dependent instruction, the processing circuitry could issue a request for the context-information-dependent operation to be performed by a different circuit unit, such as an interconnect, peripheral device, system memory management unit, hardware accelerator, or memory system component.

For example, the context-information-dependent instruction could be a context-information-dependent type of store instruction which specifies a target address and at least one source register, for which the context-information-dependent operation comprises issuing a store request to a memory system to request writing of store data to at least one memory system location corresponding to the target address, where the store data comprises source data read from the at least one source register with a portion of the source data replaced with the translated context information specified by the matching context information translation entry. This type of instruction can be useful for interacting with hardware devices, such as hardware accelerators or peripherals, which may be virtualised so that different processes executing on the processing circuitry perceive that they have their own dedicated hardware device reserved for use by that process, but in reality that hardware device is shared with other virtualised processes with the context information being used to differentiate which process requested operations to be performed by the virtualised hardware device. The store data written to the memory system may, for example, represent a command to the virtualised device. By replacing a portion of the source data with the context information, this provides a secure mechanism for communicating to a virtualised device which context has issued the command. Without support for the context information translation cache, an apparatus supporting the context-information-dependent type of store instruction may suffer from increased context switching latency due to an additional exception to remap context information on each context switch. Hence, the context information translation cache can be particularly useful to improve performance in an apparatus supporting an instruction set architecture which includes such a context-information-dependent type of store instruction.

More particularly, in some implementations the context-information-dependent type of store instruction may specify two or more source registers for providing the source data for that same instruction. The data size of the source data may be greater than the size of the data stored in one general purpose register. Providing a single instruction for transferring a larger block of data to the memory system, with support for replacing part of the source data with context information, can be extremely useful when configuring hardware accelerators.

In some examples the store request issued in response to the context-information-dependent type of store instruction may be an atomic store request which requests an atomic update to multiple memory system locations based on respective portions of the stored data. Such an atomic update may be indivisible as observed by other observers of the memory system location. That is, if another process (other than the process requesting the atomic update) requests access to any of the memory system locations subject to the atomic update, then the atomic update ensures that the other process will either see the values of the two or more memory system locations prior to any of the updates required for the atomic store request, or see the new values of those memory locations after each of the updates based on the atomic store request have been carried out. The atomic update ensures that it is not possible for another observer of the updated memory system locations to see a partial update where some of those locations have the previous values before the update and other memory locations have the new values following the update. Such an atomic store request can be useful for configuring hardware accelerators or other virtualised devices. For example, the store data may be interpreted as a command to be acted upon by the device and so it may be important that the device does not see a partial update of the relevant memory system locations, as that could risk the command being incorrectly interpreted as completely the wrong command.

In response to the atomic store request, the processing circuitry may receive an atomic store outcome indication from the memory system indicating whether the atomic update to the memory location succeeded or failed. Again this can be useful for supporting configuration of hardware accelerators or other devices. For example, the device could cause a failure indication to be returned, if, for example, its command queue does not have space to accept the command represented by the store data of the atomic store request.

Another example of the context-information-dependent instruction may be an instruction for causing an address translation cache invalidation request to be issued to request invalidation of address translation data from at least one address translation cache, where the context-information-dependent operation comprises issuing the address translation cache invalidation request to request invalidation of address translation data associated with the translated context information specified by the matching context information translation entry identified in the lookup by the lookup circuitry. The address translation cache may tag cached translation data with context information to ensure that translations for one process are not used for another process, but when virtualisation is implemented, then such context information may need to be remapped based on hypervisor control and so the context information translation cache can be useful for improving performance by reducing the need for trapping updates of the context information on each context switch.

The use of the context information translation can be particularly useful where the address translation invalidations are to be carried out in a peripheral device which is associated with a system memory management unit (SMMU) to perform address translation on behalf of the peripheral device. The SMMU may have a translation lookaside buffer for caching address translations itself and may, in response to memory access requests received from a peripheral device to request a read/write to memory, translate virtual addresses provided by the peripheral device into physical addresses used for the underlying memory system.

However, some SSMUs may also support an advance address translation function (or “address translation service”), where the peripheral device is allowed to request pre-translated addresses in advance of actually needing to access the corresponding memory locations, and the peripheral device is allowed to cache those pre-translated within an address translation cache of the peripheral device itself. Such an advance address translation function can be useful to improve performance, since at the time when the actual memory access is required the delay in obtaining the translated address is reduced and any limitations on translation bandwidth at the SMMU which might affect performance are incurred in advance at a point when the latency is not on the critical path, rather than at the time when the memory access is actually needed.

However, an issue with a system supporting such an advance address translation function is that if the software executing on the processing circuitry invalidates page table information defining the address translation mappings then any pre-translated addresses cached in the peripheral device which are associated with such invalidated mappings may themselves need to be invalidated. Hence, the processing circuitry may use the context-information-dependent instruction to trigger the SMMU to issue the address translation cache invalidation request to the peripheral device to request that any pre-translated addresses that are associated with the translated context information specified by the matching context information translation entry are invalided from the address translation cache of the peripheral device. The use of the context information translation cache can be useful because when invalidating such pre-translated addresses from the peripheral devices address translation cache, the device may have cached multiple different sets of pre-translated addresses for different execution contexts which may be interacting with the virtualised peripheral device, and so it may be needed for the invalidation request to specify which context is associated with the address translation to be invalidated, and so in the absence of the context information translation cache this may require additional hypervisor traps each time an operating system executes a context switch between application-level processes and so updates a context information storage location. With the provision of the context information translation cache many such traps can be avoided for the reasons discussed earlier.

Of course, it will be appreciated that the two examples of context-information-dependent instructions described above are not exhaustive and the context information translation cache may also be useful for other operations which depend on context information.

FIG. 1 schematically illustrates an example of a data processing apparatus 2 having processing circuitry 4 for performing data processing in response to instructions. Although not shown in the example of FIG. 1, an instruction decoder may be provided to decode the instructions fetched from a memory system and control the processing circuitry 4 to perform the corresponding operations. One type of instruction that may be supported is a context-information-dependent instruction which controls the processing circuitry 4 to perform a context-information-dependent operation based on specified context information stored within a context information storage location 6. For example the context information could identify an application, portion of an application, or thread of processing being executed by the processing circuitry 4. The context information stored in the context information storage location 6 may be set by an operating system, but may be subject to remapping by a hypervisor to support virtualisation. To accelerate such remapping, a context information translation cache 10 is provided which comprises a number of cache entries 12 which each provide, when valid, a mapping between untranslated context information 15 and translated context information 16. When a context-information-dependent instruction is executed, this causes lookup circuitry 14 to perform a lookup of the context information translation cache 10 to determine whether any of the entries 12 is valid and specifies untranslated context information 15 corresponding to the specified context information stored in the storage location 6, and if so returns translated context information 16 from the matching entry. The translated context information 16 can then be used by the processing circuitry 4 for the context-information-dependent operation. By supporting the ability to retain information on two or more different context information translation mappings within the context information translation cache 10, this reduces the need for traps to the hypervisor each time an operating system switches the information stored in the context information storage circuitry 6, improving performance.

FIG. 2 shows a more detailed example of a processing system 2 which uses such a context information translation cache 10. The system comprises a number of processing elements, for example processor cores or central processing units (CPUs) 20. It will be appreciated that other examples could have other types of processing element, such as a graphics processing unit or GPU.

A given CPU 20 comprises the processing circuitry 4 and an instruction decoder 22 for decoding the instructions to be processed by the processing circuitry 4. The CPU comprises registers 24 for storing operands for processing by the processing circuitry and storing the results generated by the processing circuitry 4. One of the registers 24 may be a context information register which acts as the context information storage location 6 described earlier. As discussed in more detail below, the registers 24 may also include other status registers or register fields for storing other identifiers EL, ASID, VMID which provide information about current processor state. The CPU also includes a memory management unit (MMU) 26 for managing address translations from virtual addresses to physical addresses, where the virtual addresses are derived from operands of memory access instructions processed by the processing circuitry 4 and the physical addresses are used to identify physical memory system locations within the memory system.

Each CPU 20 may be associated with one or more private caches 28 for caching data or instructions for faster access by the CPU 20. The respective processing elements 20 are coupled via an interconnect 30 which may manage coherency between the private caches 28. The interconnect may comprise a shared cache 32 shared between the respective processing elements 20, which could also act as a snoop filter for the purpose of managing coherency. When required data is not available in any of the caches 28, 32, then the interconnect 30 controls data to be accessed within main memory 34. While the memory 34 is shown as a single block in FIG. 2, it can be implemented as a number of separate distinct memory storage units of different types, for example some memory implemented using dynamic random access memory (DRAM) and other memory implemented using non-volatile storage.

In the example of FIG. 2 the components of a second CPU 20 are not shown in detail. The second CPU 20 may have similar components to the CPU 20 which is shown as comprising the processing circuitry 4 instruction decoder 22 etc. It will be appreciated that the system 2 may have many other elements not illustrated in FIG. 2 for conciseness.

In this example, the system includes a hardware accelerator 40 which comprises bespoke processing circuitry 42 specifically designed for carrying out a dedicated task, which is different to the general purpose processing circuitry 4 included in the CPU 20. For example, the hardware accelerator 40 could be provided for accelerating cryptographic operations, matrix multiplication operations, or other tasks. The hardware accelerator 40 may have some local storage 44, such as registers for storing operands to be processed by the processing circuitry 42 of the hardware accelerator 40, and may have a command queue 46 for storing commands which can be sent to the hardware accelerator 40 by the CPU 20. For example, the storage locations of the command queue 46 may be memory mapped registers which can be accessed by the CPU 20 using load/store instructions executed by the processing circuitry 4 which specify as their target addresses memory addresses which are mapped to locations in the command queue 46.

In the example of FIG. 2, the CPU 20 is provided with the context information translation cache 10 and the lookup circuitry 14 described above, to assist with improving performance in virtualising the context information stored in the context information register 6 which may be used for operations which interact with the hardware accelerator 40.

As shown in FIG. 3, the processing circuitry 4 in a given CPU 20 may support execution of instructions at one of a number of different privilege levels. In this example, there are at least three different privilege levels (also known as exception levels) EL0, EL1, EL2 which correspond to a first privilege level, second privilege level and third privilege level respectively. The level of privilege increases from the first privilege level to the third privilege level, so that when the processing circuitry is executing instructions at a higher level of privilege then the processing circuitry may have greater rights to read or write to registers 24 or memory than when operating at a privilege level with lower privilege. As shown in FIG. 2, the CPU registers 24 may include a control register which includes a field 46 indicating a current privilege level EL of the processing circuitry 20. Transitions between privilege levels may occur when exceptions are taken or when returning from a previously taken exception.

It will be appreciated that the labels EL0, EL1, EL2 used for the privilege levels shown in FIG. 2 are arbitrary. In other architectures, it would be possible to use a label with a smaller privilege level number to refer to a privilege level with greater privileges than a privilege level labelled with a higher privilege number. The number of privilege levels is not restricted to three. Some implementations may have further privilege levels, for example a fourth privilege level with greater privilege than the third privilege level, a further privilege level with less privilege than the first privilege level or an intermediate level of privilege between any two of the three privilege levels shown in FIG. 3.

Providing support for different privilege levels can be useful to support a virtualised software infrastructure where a number of applications defined using user-level code may execute at the first privilege level EL0, those applications may be managed by guest operating systems operating at the second privilege level EL1, and a hypervisor operating at the third privilege level EL 2 may manage different guest operating systems which co-exist on the same hardware platform.

One part of the virtualisation implemented by the hypervisor may be to control the way address translations are performed by the MMU 26. Virtual-to-physical address mappings may be defined for a particular application by the corresponding guest operating system operating at EL1. The guest operating system may define different sets of page table mappings for different applications operating under it so that aliasing virtual addresses specified by different applications can be mapped to different parts of the physical address space. From the point of view of the guest operating system, these translated physical addresses appear to be physical addresses identifying memory system locations within the memory system 28, 32, 34, 40, but actually these addresses are intermediate addresses are subject to further translation based on a further set of page tables (set by the hypervisor at EL2) mapping intermediate addresses to physical addresses.

Hence, the MMU 26 may support two-stage address translation, where a stage 1 translation from virtual addresses to intermediate addresses is performed by the MMU based on stage 1 page tables set by the guest operating system at EL1, and the intermediate addresses are translated to physical addresses in a stage 2 translation based on stage 2 page tables set by the hypervisor at EL2. This means that if different guest operating systems set their stage 1 page tables to map virtual addresses for non-shared variables used by different applications to the same intermediate addresses, this is not a problem as the hypervisor stage 2 mappings may then map these aliasing intermediate addresses to different physical addresses so that the applications will access different locations in memory. Note that it is not essential that the stage 1 and stage 2 translations are performed as two separate steps. It is possible for the MMU 26 to include a combined stage 1/stage 2 translation lookaside buffer which caches mappings direct from virtual address to physical address (set based on lookups of both the stage 1 and stage 2 page tables).

To assist with management of different stage 1 translation contexts, each application or part of an application which requires a different set of stage 1 page tables may be assigned a different address space identifier (ASID) by the corresponding guest operating system. To differentiate different stage 2 address translation contexts, the hypervisor assigns virtual machine identifiers (VMIDs) to the respective guest operating systems to indicate which type of stage 2 cables should be used when in that execution context. The combination of ASID and VMID may uniquely identify the translation context to be applied for a given software process. As shown in FIG. 2, registers 24 may include one or more control registers which include register fields for specifying the ASID 47 and VMID 48 associated with the current executing execution context. This can be used when looking up address translation mappings to ensure that the correct address translation data is obtained for the current execution context.

The context information stored in the context information register 6 could be derived from the VMID or ASID used to refer to the associated execution context for the purposes of managing address translation. However, in other cases the context information register could hold a context identifier associated with a particular execution context which is set by the operating system at EL1 independently at the VMID or ASID. Regardless of how the operating system chooses to define the context information register 6, as multiple guest operating systems may co-exist and may set aliasing values of the context information in register 6, the hypervisor EL2 may remap the information stored in the context information register 6 to differentiate execution contexts managed by different operating systems. This can be useful for handling context-information-dependent operations which depend on the context information stored in register 6.

FIG. 4 shows an example of such a context-information-dependent operation, which can be useful for interacting with a hardware accelerator 40 for example. A store instruction is provided which specifies a target address 50 using a set of one or more address operands specified by the instructions, and specifies a group of source registers 52 for providing source data 56 to be used to form store data 54 to be written to the memory system in response to the store instruction. The address operands 50 could be specified using values stored in one or more further source registers 24 specified by the store instruction and/or using an immediate value directly specified in the instruction encoding of the store instruction. The instruction supports specifying more than one source register 52 for providing the source data 56, so that the store data 54 which is to be written to the memory system has a size greater than the width of one register. For example in this example the store is a 64-byte store instruction and each register is assumed to store 64-bits (8-bytes) and so eight separate general purpose registers are specified using the source register specifiers 52 of the store instruction. Of course, the number of registers used for a particular implementation of the instruction could vary depending on the size of each register, the size of the block of data to be transferred and any other parameters of the instruction which might be able to vary the size the data to be transferred.

In response to the store instruction, the instruction decoder 22 controls the processing circuitry 4 to read the source data 56 from the group of registers identified by the source register specifiers 52 (in this example 64 bytes of data). The instruction assumes that a certain portion 58 of the source data 56 is to be replaced using context information 60 read from the context information register 6 (although as described below, there will be remapping of this value based on the context information translation cache 10). A remaining portion 62 of the store data 54 is the same as the corresponding portion of the source data 56. For example, in this implementation the portion 58 of the source data which is replaced using the context information 60 is the least significant portion of the store data. For example a certain number of least significant bits (e.g. 32 bits in this example) of the source data 56 read from the registers is replaced with the context information 60 based on information read from the context information register 60, to form the store data 54 which will be specified in a memory access store request sent to the memory system.

In this example, the particular value specified for the context information 60 in the context information register 6 (labelled as ACCDATA_EL1 in this example to denote that this register provides accelerator data which is writeable at privilege level EL1 or higher) can be set arbitrarily by an operating system operating at EL1, so does not need to be tied to context identifiers ASID, VMID use for the purposes of managing address translation. For example the operating system may wish to write context identifiers to register 6 to differentiate different sub-portions of an application which might share the same address translation tables and so may have the same value of the ASID, but nevertheless have different context information values. In other examples the context information 60 in register 6 could be derived from the ASID. Either way, it can be useful for EL1 code to set the context information which can be included in data to be transferred to memory to provide a secure mechanism by which the hardware accelerator 40 can be given commands or data associated with a particular execution context and differentiate those from commands or data provided from other contexts, so that the same hardware device of the hardware accelerator 40 can be shared for use between a number of different execution contexts in a virtualised manner. For example, the store data 54 may represent a command to be allocated into the command queue 46 of the hardware accelerator, and the context information 60 embedded into the store data can therefore be used to identify which of a number of different streams of hardware acceleration processing the command relates to.

It can be useful for the store instruction to be an atomic store instruction where the request sent to the memory system in response to the store instruction specifies that the request is to be treated as an atomic store request, which means that any memory system locations to be updated based on the store data 54 should be updated in an atomic manner which is perceived indivisibly by other observers of those storage locations. This may make it impossible for other observers (such as other execution contexts or the control logic of the hardware accelerator 40) to see partially updated values of the relevant memory system locations identified by the target address 50 (with only some of those locations taking new values while other locations still contain the old values). The particular technique for enforcing that atomicity may be implementation-dependent. For example there could be mechanisms for blocking access to certain locations until all the updates required for the atomic group of locations as a whole have been completed. Alternatively, there could be a mechanism where reads to the updates to the storage locations are allowed but hazard detection bits may be set if locations are read before all the atomic updates are completed, and the hazard detection bits may be used to detect failure of atomicity and hence reverse previous changes. The particular micro-architectural technique used to enforce an atomic access to the storage locations can vary significantly, but in general it may be useful for the instruction set architecture supported by the processing circuitry 4 to define, for the store instruction as shown in FIG. 4, an atomic guarantee so that any micro-architectural processing system implementation compliant with the architecture is required to provide a guarantee that the store data 54 will be written to the corresponding memory system locations atomically.

The instruction set architecture may also require that a response is returned in response to the store instruction, which indicates whether atomic updating of the store data to the relevant memory system locations was successful or failed. For example, the return of a failure response could be useful if, for example, the store instruction was used to write a command to a command queue 46 of the hardware accelerator 40 but the command queue is already full and so there is not currently space to accommodate the command. Also, a failure response could be returned if some of the stores were partially updated and then an external request to one of those locations was detected before all the updates have completed, so that the failure response may signal a loss of atomicity. The particular conditions in which a failure response is returned may depend on the particular micro-architectural implementation of the system.

Hence, it can be useful, for a system which supports virtualised interaction with a hardware accelerators 40 or other device which uses memory mapped storage, to support a store request which can transfer a relatively large block of data in an atomic manner with support for a pass/fail response message and the ability to replace part of the source data read from registers with context information from a context information register 6. However, in a system supporting virtualisation with different privilege levels as shown in FIG. 3, while it may be desirable for that context information to be set by an operating system at EL1, the hypervisor may wish to remap the values of the context information set by a particular operating system to avoid conflicts with context information values set by other operating systems.

On approach for handling that remapping is to trap any updates to the context information register 6 attempted by software at EL1, to signal an exception which then causes an exception handler in the hypervisor operating at EL2 to step in and determine what value should actually be stored into the context information register 6 based on the value specified by the guest operating system at EL1. However, in practice the operating system at EL1 may be updating the context information register 6 each time it context switches between different applications or portions of applications, and so this may require an additional trap to the hypervisor on each context switch which may increase context switching latency and hence reduce performance.

As shown in FIG. 5, the provision of the context information translation cache 10 and lookup circuitry 14 can help to reduce the overhead of such virtualised remapping of the context information in register 6. The context information translation cache 10 comprises a group of registers provided in hardware, which are designated as representing the contents of the context information translation cache so that each entry 12 is represented by fields in one or more registers. The registers may be architecturally accessible registers which can be read by certain software instructions. The registers which store the contents of the context information translation cache 10 are restricted for access so that they can be written to when the processing circuitry 4 is operating in EL2 or a higher privilege level, but are not writeable when operating at EL0 or EL1. The registers representing the context information translation cache 10 may still be readable at EL0 or EL1 (at least for the internal purposes of the processing circuitry when executing a context-information-dependent instruction at EL0 or EL1), although it may not necessarily be possible for software at EL0 or EL1 to be able to determine the values stored in the registers of the context information translation cache 10. In some cases reading of the context information translation cache registers when in EL0 or EL1 may be restricted only to being for the internal purposes of the processing circuitry 4 for generating translated context information, but this may be hidden from the data visible to software at EL0 or EL1 (e.g. system register access instructions for reading the contents of these registers could be reserved for execution only at EL2 or higher).

For each entry 12 of the context information translation cache 10 there is a corresponding set of one or more registers which comprises a number of fields for storing information, including: a valid field 70 for storing a valid indicator indicating whether the corresponding entry 12 is valid; an untranslated context information field 72 which specifies untranslated context information corresponding to that entry 12; and a translated context information field 74 which specifies the translated context information corresponding to the untranslated context information. In this example, each entry 12 also includes a virtual machine identifier (VMID) field 72 which specifies the VMID associated with the stage 2 translation context associated with the mapping of that entry 12.

The lookup circuitry 14 comprises content addressable memory (CAM) searching circuitry for performing various comparisons of the various untranslated context information fields 72 with corresponding context information specified for a given context-information-dependent instruction. Hence, the lookup circuitry includes comparison circuitry 80 and entry selection circuitry 82. When a context-information-dependent instruction is executed, the comparison circuitry 80 compares the context information 60 and current VMID 84 specified for the context-information-dependent instruction (read from context information register 6 and the relevant VMID field 48 of registers 24 respectively) against the corresponding information in the untranslated context information field 72 and VMID field 76 of each entry 12 within at least a portion of the context information translation cache 10. In this example, each entry 12 has its untranslated context information 72 and VMID 76 compared with the specified context information 60 from register 6 and the VMID 84, but in other examples a set-associative cache structure could be used to limit how many entries 12 have their information compared against the specified context information 60 and VMID 84 for the current instruction. Based on these comparisons, the comparison circuitry 80 determines whether the specified context information 60 and VMID 84 match the corresponding untranslated context information 72 and VMID 76 for any entry 12 of the cache 10. Based on these match indications and the valid indications 70 for each entry, entry selection circuitry 82 identifies, in the case of a cache hit, a particular entry 12 which is the matching context information translation entry which is both valid and has the untranslated context information and VMID corresponding to the specified context information 60 and VMID 84. In the case where there is a cache hit then there is no need for any exception to be triggered and instead the translated context information 74 read from the matching entry is returned and is used by the processing circuitry 4 for the purposes of the context-information-dependent operation. For example the translated context information 74 from the matching entry is used to replace the portion 58 of the source data 56 to form the store data 54 as shown in FIG. 4 for the store instruction.

On the other hand, if none of the valid entries of the context information translation cache 10 have both the untranslated context information 72 and the VMID 76 matching the corresponding value 60, 84, a miss is detected and then the lookup circuitry 14 signals an exception to cause a trap to an exception handler to be executed at EL2. The exception handling hardware may set exception syndrome information which identifies information about the cause of the exception, such as an exception type indicator distinguishing that the exception was caused by a miss in the context information translation cache 10, and/or an indication of the address of the context-information-dependent instruction which caused the exception. These can be used by the exception handling routine of the hypervisor to determine the untranslated context information which caused the miss in the cache and to determine what the translated context information corresponding to that untranslated context information should be. The software of the hypervisor may update some of the registers of the context information translation cache 10 to allocate a new entry 12 to represent the context information translation mapping for the required value of the untranslated context information. If there is no invalid context information translation cache entry 12 available for accepting that new mapping, then the software of the exception handler at EL2 may select one of the existing entries to be replaced with the mapping for the new value of the untranslated context information 60. Once any required updates to the context information translation cache 10 needed to provide a mapping for the untranslated context information in register 6 have been carried out, then the hypervisor may trigger an exception return back to the code executing at EL0 or EL1, which may then reattempt execution of the instruction which triggered the exception, and this time it may be expected that there is a cache hit so that translated context information 74 can be obtained and used to handle processing of the context-information-dependent operation (e.g. replacement of part of the store data 54 as shown in the example of FIG. 4).

Hence, with this approach, there is no longer any need to trap updates to the context information register 6, so context switching between application level processes at EL0 is faster. While occasionally there may be a trap to EL2 when attempting to execute a context-information-dependent instruction when the required remapping of the context information is not already cached in context information translation cache 10, this may happen much less frequently. In many cases, the number of simultaneous contexts being switched between may be small enough to fit in the hardware entries 12 provided in a context information translation cache 10 of a certain size (such as 16, 32 or 64 entries), so that there may be relatively few hypervisor traps needed. In any case, even if the number of mappings for different contexts being switched between is greater than the number of entries 12 provided in hardware, the number of traps the hypervisor EL2 may still be much lower than in the approach of trapping each update to the context information register 6.

While FIG. 5 shows an example where each cache entry 12 is tagged with the VMID 76 of the corresponding process at EL1, this is not essential and other implementations could omit the VMID field 76 from the cache entries 12. In this case, the software of the hypervisor may need to perform some additional operations to invalidate context information translation cache entries 10 when switching between different virtual machines or rest operating systems operating at EL1.

FIG. 6 is a flow diagram illustrating a method of processing a context-information-dependent instruction, such as the store instruction shown in FIG. 4. At step S100 the instruction decoder 22 decodes the next instruction and checks whether it is a context-information-dependent instruction, and if not, then the instruction decoder 22 controls the processing circuitry 4 to perform another type of operation and proceeds to the next instruction. If the decoded instruction is a context-information-dependent instruction then the instruction decoder 22 controls the processing circuitry 4 and lookup circuitry 14 to perform the remaining steps shown in FIG. 6. At step S102 the processing circuitry 4 reads specified context information from the context information register 6. At step S104 the lookup circuitry 14 performs a lookup of the context information translation cache based on the specified context information 60 as read from the register 6 (and optionally based on the VMID in the example shown above). At step S106 the lookup circuitry determines, based on comparisons of the specified context information against the untranslated context information fields 72 of each entry 12 in at least a subset of the context information translation cache, whether there is a hit or a miss in the cache lookup. A hit is detected if there is a matching context information translation entry which is valid and specifies untranslated context information 72 corresponding to a specified context information (and, if the VMID field 76 is supported, if the VMID field 76 of that entry matches the VMID associated with a currently active process at EL1 which is associated with the process which executed the context-information-dependent instruction). If no such matching entry is found then a miss is detected.

If a hit is detected in the lookup then at step S108 the lookup circuitry returns translated context information 74 from the valid matching entry of the context information translation cache 10. At step S110 the processing circuitry 4 causes a context-information-dependent operation to be performed based on the translated context information 74 specified by the matching context information translation entry. For example, this operation may be the replacement of the portion 58 of the source data 56 of the store instruction with the translated context information to form the store data 54 for the atomic store request as described above with respect to FIG. 4, but could also be other types of context-information-dependent operation (e.g. an address translation cache invalidation as described in the second example below).

If at step 106 a miss is detected in the lookup, then at step S112 the lookup circuitry 14 signals that an exception is to be handled at the third privilege level EL2, to deal with the fact that the required translation mapping was not available in the context information translation cache 10. A software exception handler within the hypervisor may respond to that exception, for example, by updating any information within the context information translation cache 10 to provide the missing context information translation so that the subsequent attempt to execute the context-information-dependent instruction after returning from the exception may then be successful and hit in the cache.

Hence, in this example, the context information translation cache 10 is a software-managed cache where the responsibility for managing which untranslated context information values are allocated mappings in the cache 10 lies with the software of the hypervisor which may execute instructions to update the registers of the cache 10. However, other embodiments may provide a hardware-managed cache where, in addition to the lookup circuitry 14 the context information translation cache is also associated with cache allocation control circuitry implemented in hardware circuit logic, which, in response to a miss in the lookup, controls the context information translation cache 10 to be updated with the required mapping for the specified context information 60, for example by initiating a fetch from a mapping data structure stored in the memory system which is maintained by code associated with the hypervisor at EL2. However, in practice a software-managed cache is shown in the examples above may be sufficient and may provide a better balance between hardware cost, memory footprint and performance.

In the examples above the specified context information 60 used to look up the context information translation cache is obtained from a register 6, which is a dedicated system register dedicated to providing the context information for at least the store instruction shown in FIG. 4. However, in other examples the specified context information to be used for a particular type of instruction could be obtained from a general purpose register or from a location in memory. For example, the context information to be used for a particular type of instruction could ultimately be derived from a storage structure stored in a portion of a memory 34 which is managed by code operating at EL1, and can be read into a general purpose register when required ready for executing a context-information-dependent instruction. At the time of executing the context-information-dependent instruction, the processing circuitry 4 could then read the information from the general purpose register. In this case, to prevent code at EL0 updating the context information, the page table entries for pages which store the underlying context data structure in memory may define attributes to ensure that these pages are not accessible to EL0 but can be updated by EL1. Hence, it is not essential for the context information to be stored within a dedicated register. More generally, the context information may be read from any location which can be updated at EL1 or higher.

FIG. 7 shows a flow diagram for controlling updates of the context information. When an instruction requesting updating of the context information is decoded by the instruction decoder 22 at step S120, then the subsequent steps S122-S126 are performed. As explained above, this instruction could either be a system register update instruction for updating a dedicated context information register 6, or could be a store instruction for which the target address of the store instruction is mapped to a context data structure which is maintained by EL1, where the page table entry for that address specifies that access is restricted to EL1 or higher. When such an instruction is encountered, then at step S122 it is determined whether the current privilege level is EL1 or higher, and if so then at step S124 the context information storage location specified by the instruction is updated to a new value, without the need for any trap to EL2 because hypervisor remapping of context information are handled instead in hardware using the context information translation cache 10. On the other hand, if there is an attempt to update the context information storage location from code operating at the first privilege level EL0 then at step S126 an exception is signalled to prevent the update taking place and cause an exception handler to deal with the inappropriate attempt to set the context information.

FIG. 8 shows a flow diagram illustrating a method of processing an attempt to update the context information translation cache. As mentioned above, the context information translation cache 10 may be implemented as a set of registers that are updatable only in response to instructions execution at EL2 are higher. When at step S130 the instruction decoder 22 decodes an instruction which requests an update of the context information translation cache, the subsequent steps S132-S136 are performed. For example, this instruction could be a system register updating instruction which specifies, as the register to be updated, an identifier of one of the registers used to store contents of the context information translation cache 10. When such an instruction is executed then at step S132 the processing circuitry checks whether the current privilege level is EL2 or higher, and if so then at step S134 the context information translation cache 10 is updated with a new value for at least one field as specified by the executed instruction. If there is an attempt to update the context information translation cache in response to an instruction executed at EL0 or EL1, then at step S136 this update is prohibited and an exception is signalled.

FIG. 9 illustrates the second example of a processing system 2 in which the context information translation cache 10 can be useful. In this example instead of providing a hardware accelerator 40 the system comprises a peripheral device 150 and a system memory management unit (SMMU) 152 for managing address translations on behalf of the peripheral device 150. For example the peripheral device 150 could be an off-chip device on a separate integrated circuit from the other components of the system 2. Other components of the system 2 shown in FIG. 9 are the same as the correspondingly numbered components discussed earlier with respect to FIG. 2. While FIG. 9 shows an example not having the hardware accelerator 40 described earlier, it will be appreciated that the hardware accelerator 40 could also be included and in some implementations the system of FIG. 9 could still support the store instruction described earlier with reference to FIG. 4. While FIG. 9 shows a single peripheral device 150 coupled to the SMMU 152, other examples may share the SMMU 152 between multiple different peripherals.

The SMMU 152 comprises translation circuitry 154 for translating virtual addresses specified by memory accesses issued by the peripheral device 150 into physical addresses referring to the memory system locations in the memory system. These translations may be based on the same sets of page tables which are used by the MMU 26 within the CPU 20. The SMMU 152 may have one or more translation lookaside buffers (TLBs) 156 for caching translation data for use in such translations. The SMMU may have a set of memory mapped registers 158 for storing control data which may configure the behaviour of the SMMU 152, and can be set by software executing on the CPU 20 by executing store instructions targeting memory addresses mapped to those registers 158. Similarly, the SMMU may have a command queue 160 which may queue up SMMU commands issued by the CPU 20 for requesting that the SMMU 152 performs certain actions. The CPU 20 may issue such commands by executing store instructions specifying a target memory address mapped the command queue 160, where the store data represents the contents of the command to be acted upon by the SMMU 152. As shown in FIG. 9, the SMMU 152 may also include the context information translation cache 10 and lookup circuitry 14 described earlier, for the purposes of translating context identifiers.

As shown in FIG. 10, one type of SMMU command for which the context information translation cache 10 may be useful may be an invalidation command which may cause the SMMU 152 to issue an invalidation request to the peripheral device 150 to request that any address translations associated with a specified context are invalidated from an address translation cache 162 maintained locally by the peripheral device 150. The peripheral device 150 may not itself have any address translation capability, which is why the SMMU 152 is provided to manage the translations for the peripheral 150. However, if the SMMU 152 is shared between a number of peripherals 150 there can be contention for bandwidth and resources available in the translation circuitry 154 and TLBs 156 which may cause delays for access requests issued by certain peripherals 150. Therefore, some peripherals 150 may support an advance address translation function where the peripheral 150 is allowed to request pre-translation of a particular address in advance of the time when the peripheral actually wants to access memory for that address, and then can cache the pre-translated address returned by the SMMU 152 within a pre-translated address cache 162 local to the peripheral device 150. This means that any contention for SMMU resources is incurred at a point when this delay is not on the critical timing path for the operations being performed by the peripheral device 150, since the translation is being performed in advance. At the time when the peripheral device actually wants to access memory for the given address, if the pre-translated address is already available in the peripheral device's cache 162, then it can simply issue a pre-translated access request to the SMMU 152 specifying the pre-translated address previously received and this avoids the SMMU needing to repeat the translation and so reduces the latency at the SMMU when handing the subsequent memory access. The portion of the address translation process which is performed in advance when the advance address translation function is used could be the entire address translation process (including both stage 1 and stage 2), or could alternatively only include stage 1, returning an intermediate address so that stage 2 is still to be completed at the time of performing the actual memory access. Either way the support for the advance address translation function helps reduce latency at the time of making the access to memory from the peripheral device 150.

However, when the peripheral device 150 can cache pre-translated addresses locally, there is a risk that if software executing on the CPU 20 changes the page tables for a given execution context, the peripheral device 150 could still be holding pre-translated addresses associated with the previous page tables which are now out of date, and so the CPU 20 may need a mechanism by which it can force any peripheral devices 150 which used the advance address translation function to invalidate any pre-translated addresses which are associated with the execution context for which the page table changed.

Hence, FIG. 10 shows an invalidation command instruction which can be executed by the CPU 20 to cause the peripheral device 150 to invalidate such pre-translated addresses. The instruction is a store instruction whose address operands 170 specify a memory address mapped to the command queue 160 of the SMMU 152 and whose data operands 172 specify as store data 174 information comprising a command encoding 176 which identifies the type of command as being an address translation invalidation command, a virtual address 178 specifying a single address or a range of addresses for which pre-translated addresses are to be invalided from the cache 162 of the peripheral device 150, and a stream identifier (ID) 180 which acts as context information associated with the execution context for which the addresses are to be invalidated. Note that this form of the instruction means that the context information 180 which acts as the specified context to be looked up in the context information translation cache 10 is not necessarily the context information associated with the currently active context, as this context identifier may actually refer to a previous active context which is no longer active or which is having its page tables changed. The stream ID 180 may be derived from a data structure stored in memory which is managed by the operating system at EL1, so at the time of executing the store instruction acting as the invalidation command instruction shown in FIG. 1, the stream ID 180 may be read from a general purpose register 24 to which that stream ID was previously loaded from the data structure in memory. The stream ID need not be derived from the ASID or VMID described earlier, but could be set to other arbitrary values which are allocated to a particular execution context by the operating system at EL1.

As shown in FIG. 10, when the store instruction is executed, the CPU 20 sends a store request to the memory system which identifies based on the address 170 that this address is mapped to the command queue 160 of the SMMU 152. Hence, the store data 174 representing the ATC command is written to the command queue 160. In response, the SMMU 152 identifies from the command encoding 176 that this is a command requesting that it sends a request to the peripheral device 150 to request invalidation of the pre-translated addresses. To support virtualisation of the stream ID 180 set at EL1 based on remapping controlled by the hypervisor at EL2, the specified stream ID 180 from the command 174 received from the CPU 20 is remapped using the context information translation cache 10. The specified stream ID 180 is looked up in the context information translation cache 10 by the lookup circuitry 14. If a miss is detected then an exception can be signalled to cause a trap to the hypervisor at EL2 so that the hypervisor can then update the context information translation cache 10. This time as the context information translation cache is within the SMMU 152 rather than within the system registers of the CPU 20, the instruction to be executed by the hypervisor at EL2 to update the context information translation cache 10 may be a store instruction which specifies a target address mapped to the internal registers of the SMMU 152 implementing the context information translation cache 10, rather than system register update instructions targeting internal registers 24 of the CPU 20 as in earlier example.

If a hit is detected then translated stream identification information 182 is returned, and the SMMU 152 sends an invalidation request 184 to the peripheral device 150 specifying the translated stream ID 182 and the virtual address information 178 identifying the address or range of addresses for which translations are to be invalidated. In response to the invalidation request 184, the peripheral device 150 looks up the translated stream ID 182 and virtual address information 176 in its pre-translated address cache 162 and invalidates any cache translations associated with that stream ID and virtual address information. Hence, as in the earlier embodiment the context information translation cache 10 allows the hypervisor to define different mappings between untranslated and translated context information, so that virtualisation of context information is possible without needing a trap to the hypervisor each time a different value of the untranslated context information (stream ID 180) is encountered, to reduce the frequency of hypervisor traps and hence improve performance for a virtualised system.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus comprising:
processing circuitry responsive to a context-information-dependent instruction to cause a context-information-dependent operation to be performed based on specified context information indicative of a specified execution context;
a context information translation cache to store a plurality of context information translation entries each specifying untranslated context information and translated context information; and
lookup circuitry to perform a lookup of the context information translation cache based on the specified context information specified for the context-information-dependent instruction, to identify whether the context information translation cache includes a matching context information translation entry which is valid and which specifies the untranslated context information corresponding to the specified context information, and when the context information translation cache is identified as including the matching context information translation entry, to cause the context-information-dependent operation to be performed based on the translated context information specified by the matching context information translation entry.

2. The apparatus according to claim 1, in which the context information translation cache is a software-managed cache.

3. The apparatus according to claim 1, in which when the lookup of the context information translation cache fails to identify any matching context information translation entry, the lookup circuitry is configured to trigger signalling of an exception.

4. The apparatus according to claim 1, in which the processing circuitry is configured to execute instructions at one of a plurality of privilege levels, the plurality of privilege levels including at least:
a first privilege level,
a second privilege level with greater privilege than the first privilege level, and
a third privilege level with greater privilege than the second privilege level.

5. The apparatus according to claim 4, in which the context-information-dependent instruction is allowed to be executed at the first privilege level.

6. The apparatus according to claim 4, in which in response to the context information-dependent instruction, the processing circuitry is configured to read the specified context information from a context information storage location which is updatable in response to an instruction executed at the second privilege level.

7. The apparatus according to claim 6, in which the processing circuitry is configured to allow the context information storage location to be updated in response to the instruction executed at the second privilege level without requiring a trap to the third privilege level.

8. The apparatus according to claim 6, in which each context information translation entry also specifies a second-privilege-level context identifier indicative of a second-privilege level execution context associated with a mapping between the untranslated context information and the translated context information specified by that context information translation entry; and
in the lookup of the context information translation cache, the lookup circuitry is configured to identify, as the matching context information translation entry, a context information translation entry which is valid, specifies the untranslated context information corresponding to the specified context information, and specifies the second-privilege-level context identifier corresponding to a current second-privilege-level context associated with the context-information-dependent instruction.

9. The apparatus according to claim 4, in which when the lookup of the context information translation cache fails to identify any matching context information translation entry, the lookup circuitry is configured to trigger signalling of an exception to be handled at the third privilege level.

10. The apparatus according to claim 4, in which the context information translation entries of the context information translation cache are allowed to be updated in response to an instruction executed at the third privilege level and are prohibited from being updated in response to an instruction executed at the first privilege level or the second privilege level.

11. The apparatus according to claim 1, in which when the context-information-dependent instruction is a context-information-dependent type of store instruction specifying a target address and at least one source register, the context-information-dependent operation comprises issuing a store request to a memory system to request writing of store data to at least one memory system location corresponding to the target address, the store data comprising source data read from the at least one source register with a portion of the source data replaced with the translated context information specified by the matching context information translation entry.

12. The apparatus according to claim 11, in which the context-information-dependent type of store instruction specifies a plurality of source registers for providing the source data.

13. The apparatus according to claim 11, in which the store request is an atomic store request requesting an atomic update to a plurality of memory system locations based on respective portions of the store data.

14. The apparatus according to claim 13, in which in response to the store request issued in response to the store instruction, the processing circuitry is configured to receive an atomic store outcome indication from the memory system indicating whether the atomic update to the plurality of memory locations succeeded or failed.

15. The apparatus according to claim 1, in which when the context-information-dependent instruction is an instruction for causing an address translation cache invalidation request to be issued to request invalidation of address translation data from at least one address translation cache, the context-information-dependent operation comprises issuing the address translation cache invalidation request to request invalidation of address translation data associated with the translated context information specified by the matching context information translation entry.

16. The apparatus according to claim 15, comprising a system memory management unit to perform address translation on behalf of a peripheral device, where the system memory management unit is configured to support an advance address translation function in which the peripheral device is allowed to cache pre-translated addresses within an address translation cache of the peripheral device; and
the address translation cache invalidation request is a request to invalidate pre-translated addresses from the address translation cache of the peripheral device that are associated with the translated context information specified by the matching context information translation entry.

17. An apparatus comprising:
means for processing, responsive to a context-information-dependent instruction to cause a context-information-dependent operation to be performed based on specified context information indicative of a specified execution context;
means for caching context information translations, to store a plurality of context information translation entries each specifying untranslated context information and translated context information; and
means for performing a lookup of the means for caching based on the specified context information specified for the context-information-dependent instruction, to identify whether the means for caching includes a matching context information translation entry which is valid and which specifies the untranslated context information corresponding to the specified context information, and when the means for caching is identified as including the matching context information translation entry, to cause the context-information-dependent operation to be performed based on the translated context information specified by the matching context information translation entry.

18. A method comprising:
in response to a context-information-dependent instruction processed by processing circuitry:
performing a lookup of a context information translation cache based on specified context information specified for the context-information-dependent instruction, the specified context information indicative of a specified execution context, where the context information translation cache is configured to store a plurality of context information translation entries each specifying untranslated context information and translated context information;
based on the lookup, identifying whether the context information translation cache includes a matching context information translation entry which is valid and which specifies the untranslated context information corresponding to the specified context information; and
when the context information translation cache is identified as including the matching context information translation entry, causing a context-information-dependent operation to be performed based on the translated context information specified by the matching context information translation entry.
